(19) United States
(12) Patent Application Publication
(10) Pub. No.: US 2011/0007039 A1
(43) Pub. Date: Jan. 13, 2011

(54) PLASMA DISPLAY APPARATUS

(76) Inventors: Heekwon Kim, Gumi (KR); Jinyoung Kim, Gumi (KR)

Correspondence Address: BIRCH STEWART KOLASCH & BIRCH, PO BOX 747, FALLS CHURCH, VA, 22040-0747, US

(21) Appl. No.: 12/673,739

(22) PCT Filed: Apr. 25, 2008
(86) PCT No.: PCT/KR08/02359

§ 371 Date: Feb. 16, 2010

(30) Foreign Application Priority Data
Nov. 5, 2007 (KR) 10-2007-0111923

(51) Int. Cl. G09G 5/00

(52) U.S. Cl. 345/204; 345/60

(57) ABSTRACT

A plasma display apparatus is disclosed. The plasma display apparatus includes a plasma display panel and a driver. The plasma display panel includes a front substrate on which a plurality of scan electrodes and a plurality of sustain electrode are positioned substantially parallel to each other, a rear substrate on which a plurality of address electrodes are positioned to intersect the scan electrodes and the sustain electrodes, and a phosphor layer that is positioned between the front substrate and the rear substrate and includes a phosphor material and MgO material. The driver supplies scan signals to the plurality of scan electrodes at different times of an address period of a subfield in an active area.

### TECHNICAL FIELD

An exemplary embodiment relates to a plasma display apparatus.

### BACKGROUND ART

A plasma display apparatus includes a plasma display panel.

The plasma display panel includes a phosphor layer inside discharge cells partitioned by bather ribs and a plurality of electrodes.

When driving signals are applied to the electrodes of the plasma display panel, a discharge occurs inside the discharge cells. In other words, when the plasma display panel is discharged by applying the (hiving signals to the discharge cells, a discharge gas filled in the discharge cells generates vacuum ultraviolet rays, which thereby cause phosphors positioned between the barrier ribs to emit light, thus producing viable light. An image is displayed on the screen of the plasma display panel due to the visible light.

### Disclosure of Invention

### BRIEF DESCRIPTION OF THE DRAWINGS

FIG. 1 shows a configuration of a plasma display apparatus according to an exemplary embodiment;

FIG. 2 shows a structure of a plasma display panel according to the exemplary embodiment;

FIG. 3 shows a frame for achieving a gray scale of an image in the plasma display apparatus;

FIG. 4 illustrates an example of an operation of the plasma display apparatus;

FIG. 5 shows a phosphor layer;

FIG. 6 illustrates an example of a method of manufacturing a phosphor layer;

FIGS. 7 and 8 are diagrams for explaining an effect of an additive material;

FIG. 9 is a diagram for explaining a content of an additive material;

FIG. 10 shows another structure of a phosphor layer;

FIG. 11 illustrates an example of a method of manufacturing a phosphor layer of FIG. 10;

FIG. 12 is a diagram for explaining a method of selectively using an additive material;

FIG. 13 is a diagram for explaining a method of supplying a data signal;

FIGS. 14 and 15 are diagrams for explaining a method of supplying a scan signal;

FIG. 16 is a diagram for explaining another method of supplying a data signal;

FIG. 17 is a diagram for explaining another method of supplying a scan signal; and

FIGS. 18 and 19 are diagrams for explaining a width of a scan signal.

### MODE FOR THE INVENTION

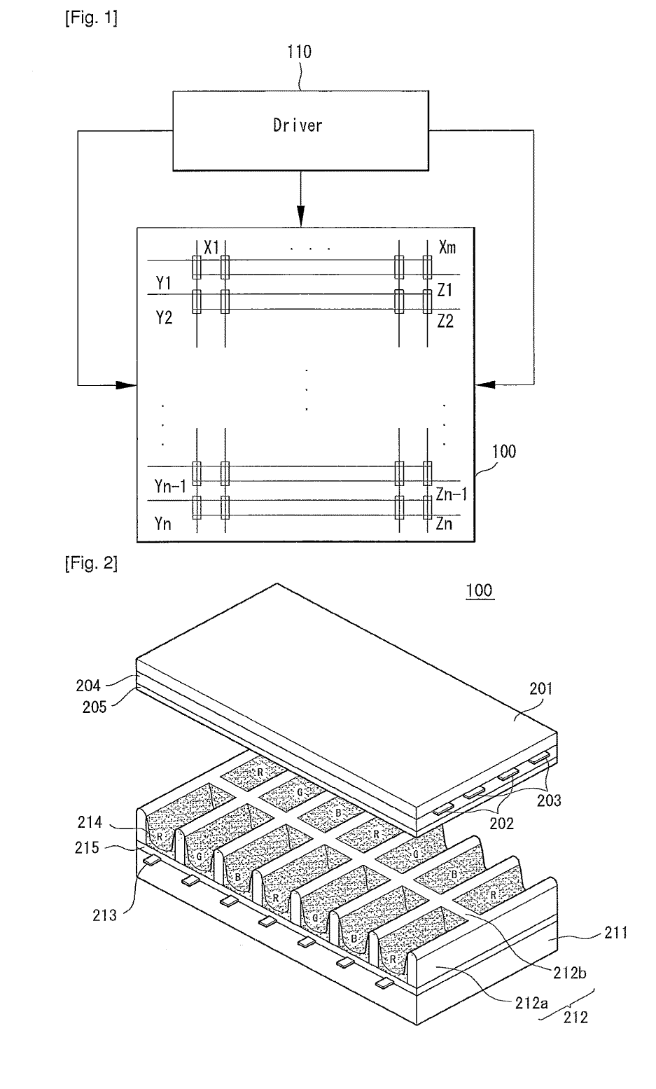

FIG. 1 shows a configuration of a plasma display apparatus according to an exemplary embodiment.

As shown in FIG. 1, the plasma display apparatus according to the exemplary embodiment includes a plasma display panel 100 and a driver 110.

The plasma display panel 100 includes scan electrodes Y1-Yn and sustain electrodes Z1-Zn positioned parallel to each other, and address electrodes X1-Xm positioned to intersect the scan electrodes Y1-Yn and the sustain electrodes Z1-Zn.

The diver 110 supplies a driving signal to at least one of the scan electrode, the sustain electrode, or the address electrode to display thereby an image on the screen of the plasma display panel 100.

Although FIG. 1 has shown the case that the driver 110 is formed in the form of a signal board, the driver 110 may be formed in the form of a plurality of boards depending on the electrodes formed in the plasma display panel 100. For example, the driver 110 may include a first driver (not shown) for driving the scan electrodes Y1-Yn, a second driver (not shown) for driving the sustain electrodes Z1-Zn, and a third driver (not shown) for driving the address electrodes X1-Xm.

FIG. 2 shows a structure of a plasma display panel according to the exemplary embodiment.

As shown in FIG. 2, the plasma display panel 100 according to the exemplary embodiment may include a front substrate 201, on which a scan electrode 202 and a sustain electrode 203 are positioned parallel to each other, and a rear substrate 211 on which an address electrode 213 is positioned to intersect the scan electrode 202 and the sustain electrode 203.

An upper dielectric layer 204 may be positioned on the scan electrode 202 and the sustain electrode 203 to limit a discharge current of the scan electrode 202 and the sustain electrode 203 and to provide electrical insulation between the scan electrode 202 and the sustain electrode 203.

A protective layer 205 may be positioned on the upper dielectric layer 204 to facilitate discharge conditions. The protective layer 205 may include a material having a high secondary electron emission coefficient, for example, magnesium oxide (MgO).

A lower dielectric layer 215 may be positioned on the address electrode 213 to cover the address electrode 213 and to provide electrical insulation of the address electrodes 213.

Bather ribs 212 of a stripe type, a well type, a delta type, a honeycomb type, and the like, may be positioned on the lower dielectric layer 215 to partition discharge spaces (i.e., discharge cells). Hence, a first discharge cell emitting red (R) light, a second discharge cell emitting blue (B) light, and a third discharge cell emitting green (G) light, and the like, may be positioned between the front substrate 201 and the rear substrate 211. In addition to the first, second, and third discharge cells, a fourth discharge cell emitting white (W) light or yellow (Y) light may be further positioned.

Widths of the first, second, and third discharge cells may be substantially equal to one another. Further, a width of at least one of the first, second, and third discharge cells may be different from widths of the other discharge cells. For instance, a width of the first discharge cell may be the smallest, and widths of the second and third discharge cells may be larger than the width of the first discharge cell. The width of the second discharge cell may be substantially equal to or different from the width of the third discharge cell. Hence, a color temperature of an image displayed on the plasma display panel 100 can be improved.

The plasma display panel 100 may have various forms of barrier rib structures as well as a structure of the bather rib 212 shown in FIG. 2. For instance, the barrier rib 212 includes a first barrier rib 212b and a second barrier rib 212a. The barrier rib 212 may have a differential type barrier rib structure in which heights of the first and second barrier ribs 212b and 212a are different from each other, a channel type barrier rib structure in which a channel usable as an exhaust path is formed on at least one of the first barrier rib 212b or the second barrier rib 212a, a hollow type barrier rib structure in which a hollow is formed on at least one of the first barrier rib 212b or the second barrier rib 212a, and the like.

In the differential type barrier rib structure, a height of the first barrier rib 212b may be smaller than a height of the second barrier rib 212a. In the channel type barrier rib structure, a channel may be formed on the first barrier rib 212b.

While FIG. 2 has shown and described the case where the first, second, and third discharge cells are arranged on the same line, the first, second, and third discharge cells may be arranged in a different pattern. For instance, a delta type arrangement in which the first, second, and third discharge cells are arranged in a triangle shape may be applicable. Further, the discharge cells may have a variety of polygonal shapes such as pentagonal and hexagonal shapes as well as a rectangular shape.

Each of the discharge cells partitioned by the barrier ribs 212 may be filled with a discharge gas.

A phosphor layer 214 may be positioned inside the discharge cells to emit visible light for an image display diming an address discharge. For instance, first, second, and third phosphor layers that produce red, blue, and green light, respectively, may be positioned inside the discharge cells. In addition to the first, second, and third phosphor layers, a fourth phosphor layer producing white and/or yellow light may be further positioned.

A thickness of at least one of the first, second, and third phosphor layers may be different from thicknesses of the other phosphor layers. For instance, a thickness of the second phosphor layer or the third phosphor layer may be larger than a thickness of the first phosphor layer. The thickness of the second phosphor layer may be substantially equal or different from the thickness of the third phosphor layer.

In FIG. 2, the upper dielectric layer 204 and the lower dielectric layer 215 each have a single-layered structure. However, at least one of the upper dielectric layer 204 or the lower dielectric layer 215 may have a multi-layered structure.

A black layer (not shown) capable of absorbing external light may be further positioned on the barrier rib 212 to prevent the external light from being reflected by the barrier rib 212. Further, another black layer (not shown) may be further positioned at a predetermined location of the front substrate 201 to correspond to the barrier rib 212.

While the address electrode 213 may have a substantially constant width or thickness, a width or thickness of the address electrode 213 inside the discharge cell may be different from a width or thickness of the address electrode 213 outside the discharge cell. For instance, a width or thickness of the address electrode 213 inside the discharge cell may be larger than a width or thickness of the address electrode 213 outside the discharge cell.

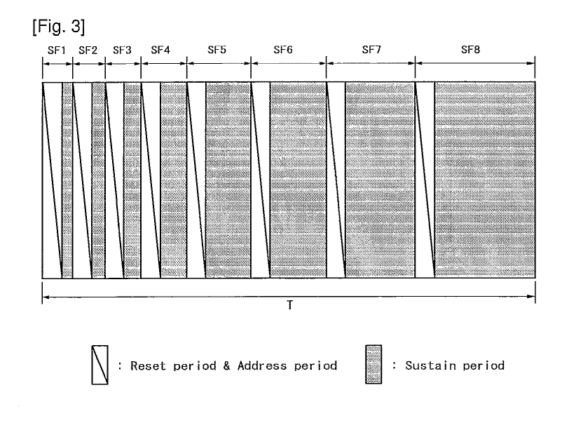

FIG. 3 shows a frame for achieving a gray scale of an image in the plasma display apparatus.

As shown in FIG. 3, a frame for achieving a gray scale of an image displayed by the plasma display apparatus according to the exemplary embodiment is divided into several subfields each having a different number of emission times.

Each subfield is subdivided into a reset period for initializing all the cells, an address period for selecting cells to be discharged, and a sustain period for representing gray level in accordance with the number of discharges.

For example, if an image with 256-level gray scale is to be displayed, a frame, as shown in FIG. 3, is divided into 8 subfields SF1 to SF8. Each of the 8 subfields SF1 to SF8 is subdivided into a reset period, an address period, and a sustain period.

The number of sustain signals supplied dining the sustain period determines a subfield weight of each subfield. For example, in such a method of setting a subfield weight of a first subfield SF1 at 2⁰ and a subfield weight of a second subfield at 2¹, a subfield weight of each subfield increases in a ratio of 2 ⁿ (where, n=0, 1, 2, 3, 4, 5, 6, 7). Various images can be displayed by controlling the number of sustain signals supplied during a sustain period of each subfield depending on a subfield weight of each subfield.

Although FIG. 3 has shown and described the case where one frame includes 8 subfields, the number of subfields constituting one frame may vary. For example, one frame may include 12 subfields or 10 subfields.

Further, although FIG. 3 has illustrated and described the subfields arranged in increasing order of gray level weight, the subfields may be arranged in decreasing order of gray level weight, or the subfields may be arranged regardless of gray level weight.

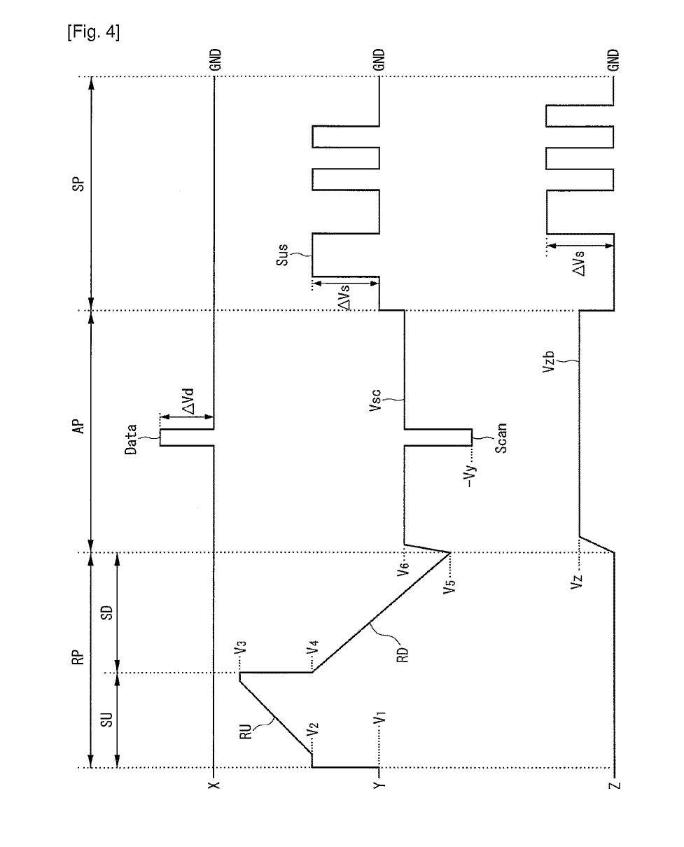

FIG. 4 illustrates an example of an operation of the plasma display apparatus. Driving signals to be described with reference to FIG. 4 are supplied by the driver 110 of FIG. 1.

As shown in FIG. 4, during a reset period RP for initialization, a reset signal is supplied to the scan electrode Y. The reset signal includes a rising signal RU and a falling signal RD. The reset period is further divided into a setup period SU and a set-down period SD.

The rising signal RU is supplied to the scan electrode Y dining the setup period SU, thereby generating a weak dark discharge (i.e., a setup discharge) inside the discharge cell. Hence, a proper amount of wall charges are accumulated inside the discharge cell.

The falling signal RD of a polarity opposite a polarity of the rising signal RU is supplied to the scan electrode Y during the set-down period SD, thereby generating a weak erase discharge (i.e., a set-down discharge) inside the discharge cell. Hence, the remaining wall charges are uniform inside the discharge cells to the extent that an address charge occurs stably.

During an address period AP following the reset period RP, a scan bias signal Vsc, whish is substantially maintained at a sixth voltage V6 higher than a lowest voltage V5 of the falling signal RD, is supplied to the scan electrode Y. A scan signal (Scan) falling from the scan bias signal Vsc is supplied to the scan electrode Y.

A width of a scan signal supplied during an address period of at least one subfield may be different from widths of scan signals supplied during address periods of the other subfields. A width of a scan signal in a subfield may be larger than a width of a scan signal in a next subfield in time order. For instance, a width of the scan signal may be gradually reduced in the order of 2.6 μs, 2.3 μs, 2.1 μs, 1.9 μs, etc, or may be reduced in the order of 2.6 μs, 2.3 μs, 2.3 μs, 2.1 μs . . . . . . 1.9 μs, 1.9 μs, etc, in the successively arranged subfields.

When the scan signal (Scan) is supplied to the scan electrode Y, a data signal (Data) corresponding to the scan signal (Scan) is supplied to the address electrode X.

As the voltage difference between the scan signal (Scan) and the data signal (Data) is added to the wall voltage produced during the reset period RP, the address discharge occurs inside the discharge cell to which the data signal (Data) is supplied.

A sustain bias signal Vzb is supplied to the sustain electrode Z during the address period AP so as to prevent the generation of unstable address discharge by interference of the sustain electrode Z. The sustain bias signal Vzb may be substantially maintained at a sustain bias voltage Vz. The sustain bias voltage Vz is lower than a voltage Vs of a sustain signal (Sus) and is higher than a ground level voltage GND.

During a sustain period SP following the address period AP, the sustain signal (Sus) may be supplied to at least one of the scan electrode Y or the sustain electrode Z. For instance, the sustain signal (Sus) is alternately supplied to the scan electrode Y and the sustain electrode Z.

As the wall voltage inside the discharge cell selected by performing the address discharge is added to the sustain voltage Vs of the sustain signal (Sus), every time the sustain signal (Sus) is supplied, a sustain discharge, i.e., a display discharge occurs between the scan electrode Y and the sustain electrode Z.

A plurality of sustain signals are supplied during a sustain period of at least one subfield, and a width of at least one of the plurality of sustain signals may be different from widths of the other sustain signals. For instance, a width of a first supplied sustain signal among the plurality of sustain signals may be larger than widths of the other sustain signals. Hence, a sustain discharge can more stably occur.

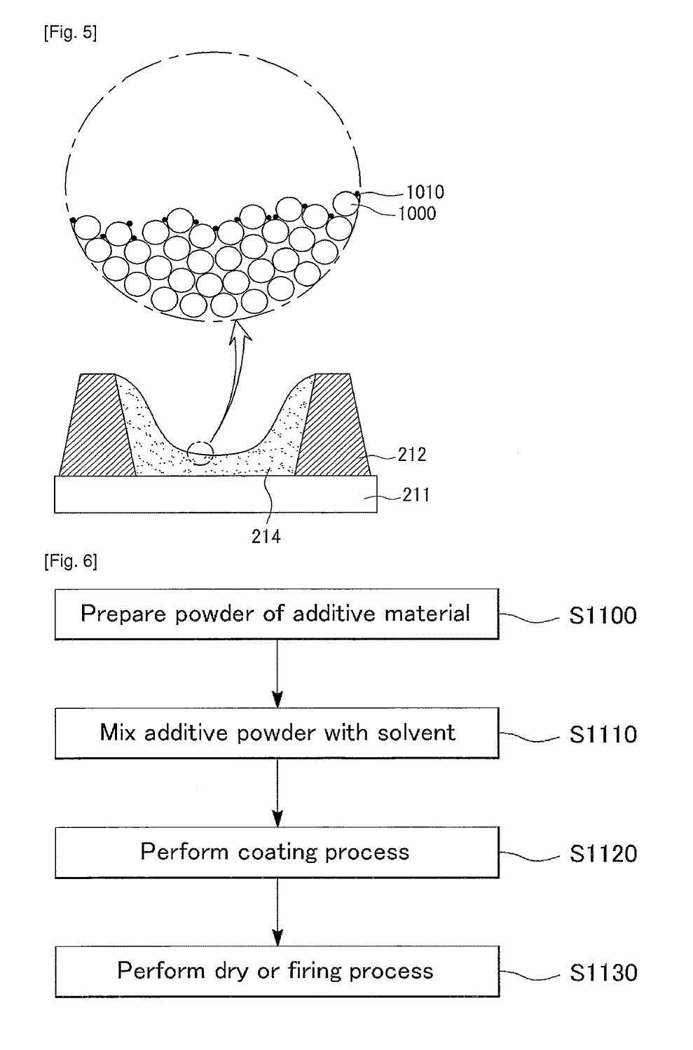

FIG. 5 shows a phosphor layer.

As shown in FIG. 5, the phosphor layer 214 includes particles 1000 of a phosphor material and particles 1010 of an additive material.

The parities 1010 of the additive material can improve a discharge response characteristic between the scan electrode and the address electrode or between the sustain electrode and the address electrode. This will be below desalted in detail.

When a scan signal is supplied to the scan electrode and a data signal is supplied to the address electrode, charges may be accumulated on the surface of the particles 1000 of the phosphor material.

If the phosphor layer 214 does not include an additive material, charges may be concentratedly accumulated on a specific portion of the phosphor layer 214 because of the nonuniform height of the phosphor layer 214 and the nonuniform distribution of the particles of the phosphor material. Hence, a relatively strong discharge may occur in the specific portion of the phosphor layer 214 on which charges are concentratedly accumulated.

Further, charges may be concentratedly accumulated in a different area of each discharge cell, and thus a discharge may occur unstably and nonuniformly. In this case, the image quality of a displayed image may worsen, and thus a viewer may watch a noise such as spots.

On the other hand, in case that the phosphor layer 214 includes the additive material such as MgO as in the exemplary embodiment, the additive material acts as a catalyst of a discharge. Hence, a discharge can stably occur between the scan electrode and the address electrode at a relatively low voltage. Accordingly, before the strong discharge occurs at a relatively high voltage in the specific portion of the phosphor layer 214, on which charges are concentratedly accumulated, a discharge can occur at a relatively low voltage in a portion of the phosphor layer 214, on which the particles of the additive material are positioned. Hence, discharge characteristics of each discharge cell can be uniform. This is caused by a reason why the additive material has a high secondary electron emission coefficient.

The additive material is not limited particularly except the improvement of the discharge response characteristic between the scan electrode and the address electrode or between the sustain electrode and the address electrode. Examples of the additive material include at least one of magnesium oxide (MgO), zinc oxide (ZnO), silicon oxide (SiO₂), titanium oxide (TiO₂), yttrium oxide (Y₂O₃), aluminum oxide (Al₂O₃), lanthanum oxide (La₂O₃), europium oxide (EuO), cobalt oxide, iron oxide, or CNT (carbon nano tube). It may be advantageous that the additive material is MgO.

At least one of the particles 1000 of the phosphor material on the surface of the phosphor layer 214 may be exposed in a direction toward the center of the discharge cell. For instance, since the particles 1010 of the additive material are disposed between the particles 1000 of the phosphor material on the surface of the phosphor layer 214, at least one particle 1000 of the phosphor material may be exposed.

As described above, when the particles 1010 of the additive material are disposed between the particles 1000 of the phosphor material, a discharge response characteristic between the scan electrode and the address electrode or between the sustain electrode and the address electrode can be improved. Further, since the surface area of the particles 1000 of the phosphor material covered by the parities 1010 of the additive material may be minimized, an excessive reduction in a luminance can be prevented.

Although it is not shown, if the particles 1010 of the additive material are uniformly coated on the surface of the phosphor layer 214, and a layer formed of the additive material is formed on the surface of the phosphor layer 214, the additive layer covers the most of the surface of the particles 1000 of the phosphor material. Hence, a luminance may be excessively reduced.

FIG. 6 illustrates an example of a method of manufacturing a phosphor layer.

As shown in FIG. 6, first, a powder of an additive material is prepared in step S1100. For instance, a gas oxidation process is performed on Mg vapor generated by heating Mg to form a powder of MgO.

Next, the prepared additive power is mixed with a solvent in step S1110. For instance, the resulting MgO powder is mixed with methanol to manufacture an additive paste or an additive slurry. A binder may be added so as to adjust a viscosity of the additive paste or the additive slurry.

Subsequently, the additive paste or slurry is coated on the phosphor layer in step S1120. In this case, a viscosity of the additive paste or the additive slurry is adjusted so that the particles of the additive material are smoothly positioned between the particles of the phosphor material.

Subsequently, a dry process or a firing process is performed in step S1130. Hence, the solvent mixed with the additive material is evaporated to form the phosphor layer of FIG. 5.

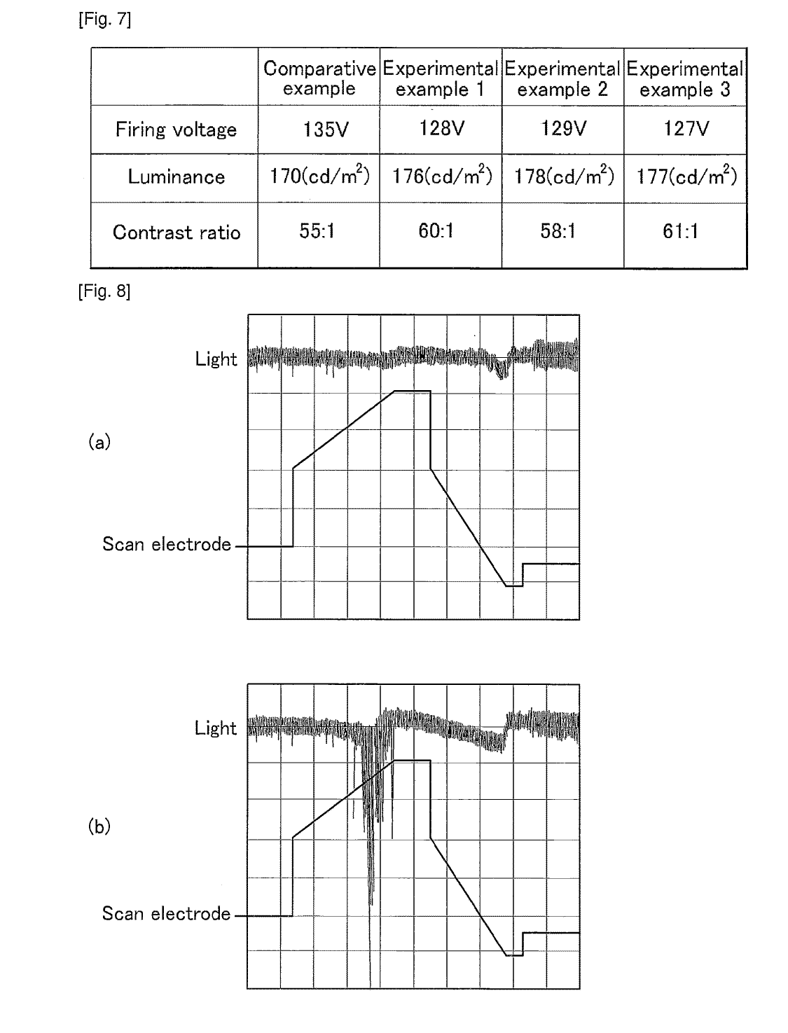

FIGS. 7 and 8 are diagrams for explaining an effect of an additive material.

FIG. 7 is a table showing a filing voltage, a luminance of a displayed image, and a bright room contrast ratio of each of a comparative example and experimental examples 1, 2 and 3. The bright room contrast ratio measures a contrast ratio in a state where an image with a window pattern occupying 45% of the screen size is displayed in a bright room. The firing voltage is a firing voltage measured between the scan electrode and the address electrode.,

In the comparative example, the phosphor layer does not include an additive material.

In the experimental example 1, the phosphor layer includes MgO of 3% based on the volume of the phosphor layer as an additive material.

In the experimental example 2, the phosphor layer includes MgO of 9% based on the volume of the phosphor layer as an additive material.

In the experimental example 3, the phosphor layer includes MgO of 12% based on the volume of the phosphor layer as an additive material.

In the comparative example, the firing voltage is 135V, and the luminance is 170 cd/m².

In the experimental examples 1, 2 and 3, the firing voltage is 127V to 129V lower than the firing voltage of the comparative example, and the luminance is 176 cd/m² to 178 cd/m² higher than the luminance of the comparative example. Because the particles of the MgO material as the additive material in the experimental examples 1, 2 and 3 act as a catalyst of a discharge, the firing voltage between the scan electrode and the address electrode is lowered. Furthermore, in the experimental examples 1, 2 and 3, because an intensity of a discharge generated at the same voltage as the comparative example increases due to a fall in the firing voltage, the luminance further increases.

While the bright room contrast ratio of the comparative example is 55:1, the bright room contrast ratio of the experimental examples 1, 2 and 3 is 58:1 to 61:1. As can be seen from FIG. 7, a contrast characteristic of the experimental examples 1, 2 and 3 is more excellent than that of the comparative example.

In the experimental examples 1, 2 and 3, a uniform discharge occurs at a lower firing voltage than that of the comparative example, and thus the quantity of light during a reset period is relatively small in the experimental examples 1, 2 and 3.

In FIG. 8, (a) is a graph showing the quantity of light in the experimental examples 1, 2 and 3, and (b) is a graph showing the quantity of light in the comparative example.

As shown in (b) of FIG. 8, because an instantaneously strong discharge occurs at a relatively high voltage in the comparative example not including the MgO material, the quantity of light may instantaneously increase. Hence, the contrast characteristics may worsen.

As shown in (a) of FIG. 8, because a discharge occurs at a relatively low voltage in the experimental examples 1, 2 and 3 including the MgO material, a weak reset discharge continuously occurs during a reset period. Hence, a small quantity of light is generated, and the contrast characteristics can be improved.

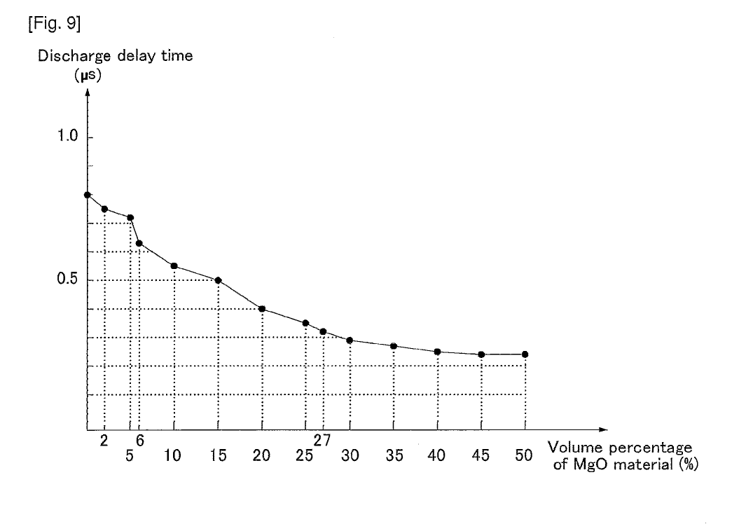

FIG. 9 is a graph measuring a discharge delay time of an address discharge while a percentage of a volume of MgO material used as an additive material based on the volume of the phosphor layer changes from 0% to 50%.

The address discharge delay time means a time interval between a time when the scan signal and the data signal are supplied during an address period and a time when an address discharge occurs between the scan electrode and the address electrode.

As shown in FIG. 9, when the volume percentage of the MgO material is 0 (in other words, when the phosphor layer does not include MgO material), the discharge delay time may be approximately 0.8 μs.

When the volume percentage of the MgO material is 2%, the discharge delay time is reduced to be approximately 0.75 μs. In other words, because the particles of the MgO material improve a discharge response characteristic between the scan electrode and the address electrode, an address jitter characteristic can be improved.

Further, when the volume percentage of the MgO material is 5%, the discharge delay time may be approximately 0.72 μs. When the volume percentage of the MgO material is 6%, the discharge delay time may be approximately 0.63 μs.

When the volume percentage of the MgO material lies in a range between 10% and 50%, the discharge delay time may be reduced from approximately 0.55 μs to 0.24 μs.

It can be seen from the graph of FIG. 9 that as a content of the MgO material increases, the discharge delay time can be reduced. Hence, the address jitter characteristic can be improved. However, an improvement width of the address jitter characteristic may gradually decrease. In case that the volume percentage of the MgO material is equal to or more than 40%, a reduction width of the discharge delay time may be small.

On the other hand, in case that the volume percentage of the MgO material is excessively large, the particles of the MgO material may excessively cover the surface of the particles of the phosphor material. Hence, a luminance may be reduced.

Accordingly, the percentage of the volume of the MgO material based on the volume of the phosphor layer may lie substantially in a range between 2% and 40% or between 6% and 27% so as to reduce the discharge delay time and to prevent an excessive reduction in the luminance.

The particles of the MgO material included in the phosphor layer may have one orientation or two or more different orientations. For instance, only (200)-oriented MgO material may be used, or (200)- and (111)-oriented MgO material may be used. However, (200)-oriented MgO material and (111)-oriented MgO material may be together used so as to improve a discharge response characteristic between the scan electrode and the address electrode or between the sustain electrode and the address electrode and to prevent the degradation of the phosphor layer.

For instance, while the (111)-oriented MgO material has a relatively higher secondary electron emission coefficient than the (200)-oriented MgO material, the (111)-oriented MgO material has a relatively weaker sputter resistance than the (200)-oriented MgO material. Further, wall charges accumulating characteristic of the (111)-oriented MgO material is weaker than that of the (200)-oriented MgO

Accordingly, in case that only the (111)-oriented MgO material is used, it is possible to improve a discharge response characteristic between the scan electrode and the address electrode or between the sustain electrode and the address electrode. However, it is difficult to prevent the degradation of the phosphor layer.

On the other hand, in case that only the (200)-oriented MgO material is used, it is possible to prevent the degradation of the phosphor layer. However, it is difficult to improve a discharge response characteristic between the scan electrode and the address electrode or between the sustain electrode and the address electrode.

Accordingly, the (200)-oriented MgO material and the (111)-oriented MgO material may be together used so as to improve the discharge response characteristic between the scan electrode and the address electrode or between the sustain electrode and the address electrode and to prevent the degradation of the phosphor layer.

In case that the phosphor layer includes the MgO material, the amount of charges accumulated on the surface of the phosphor layer may increase. As a result, the degradation of the phosphor particles may be accelerated. Accordingly, a content of the (200)-oriented MgO material having the relatively stronger sputter resistance may be more than a content of the (111)-oriented MgO material, so as to prevent the degradation of the phosphor particles.

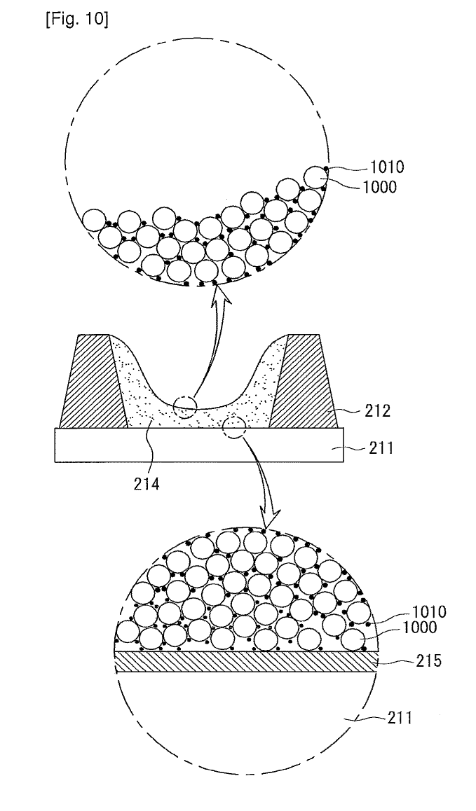

FIG. 10 shows another structure of a phosphor layer.

As shown in FIG. 10, the particles 1010 of the additive material may be positioned on the surface of the phosphor layer 214, inside the phosphor layer 214, and between the phosphor layer 214 and the lower dielectric layer 215.

When the particles 1010 of the additive material may be positioned on the surface of the phosphor layer 214, inside the phosphor layer 214, and between the phosphor layer 214 and the lower dielectric layer 215, a discharge response characteristic between the scan electrode and the address electrode or between the sustain electrode and the address electrode can be improved.

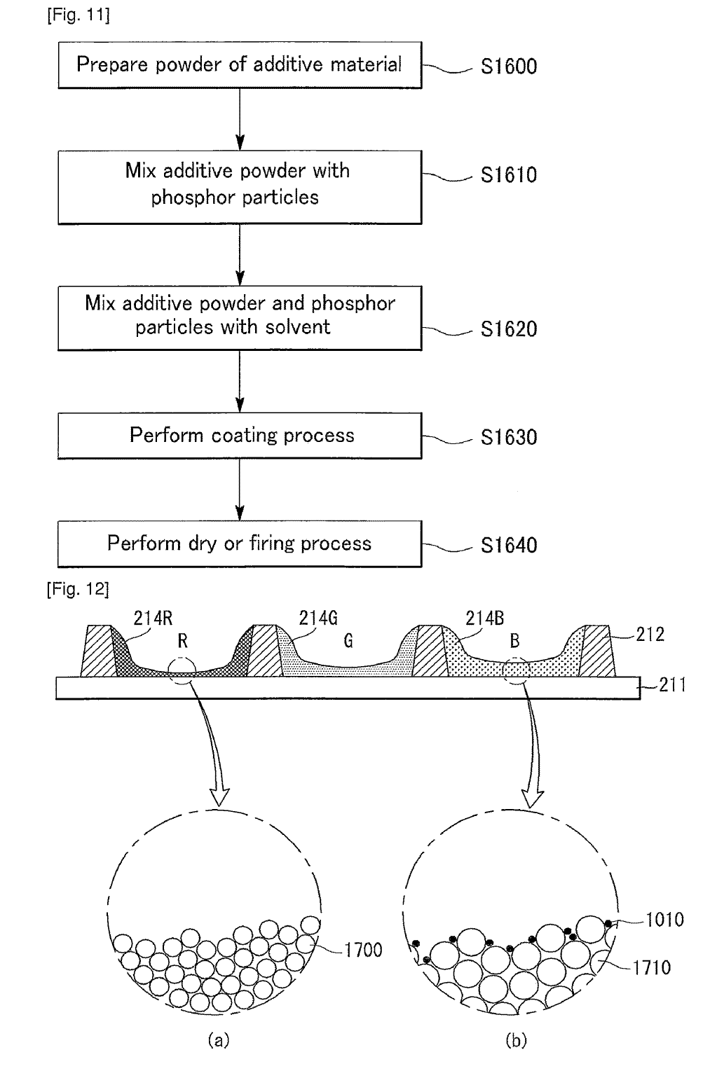

FIG. 11 illustrates an example of a method of manufacturing a phosphor layer of FIG. 10.

As shown in FIG. 11, a powder of an additive material is prepared in step S1600.

The prepared additive power is mixed with phosphor particles in step S1610.

The additive power and the phosphor particles are mixed with a solvent in step S1620.

The additive power and the phosphor particles mixed with the solvent are coated inside the discharge cells in step S1630. In the coating process, a dispensing method may be used.

A dry process or a fling process is performed in step S1640 to evaporate the solvent. Hence, the phosphor layer having the structure shown in FIG. 10 is formed.

FIG. 12 is a diagram for explaining a method of selectively using an additive material.

As shown in FIG. 12, the phosphor layer includes a first phosphor layer 214R emitting red light, a second phosphor layer 214B emitting blue light, and a third phosphor layer 214G emitting green light. At least one of the first phosphor layer 214R, the second phosphor layer 214B, or the third phosphor layer 214G may not include the additive material.

For instance, as shown in (a), the first phosphor layer 214R includes particles 1700 of a first phosphor material, but does not include an additive material. As shown in (b), the second phosphor layer 214B includes particles 1710 of a second phosphor material and particles 1010 of an additive material. In this case, the quantity of light generated in the second phosphor layer 214B can increase, and thus a color temperature can be improved.

The size of the particles 1710 of the second phosphor material in (b) may be larger than the size of the particles 1700 of the first phosphor material in (a). In this case, a discharge in the second phosphor layer 214B in (b) may be more unstable than a discharge in the first phosphor layer 214R in (a). However, because the second phosphor layer 214B includes the particles 1010 of the additive material, the discharge in the second phosphor layer 214B can be stabilized.

FIG. 13 is a diagram for explaining a method of supplying a data signal.

As shown in FIG. 13, the driver may include a data driver 1500, a scan driver 1510, and a sustain driver 1520.

The scan diver 1510 supplies scan signals to the scan electrodes Y1-Yn, the sustain driver 1520 supplies sustain signals to the sustain electrodes Z1-Zn, and the data driver 1500 supplies data signals to the address electrodes X1-Xm.

The data signals are supplied to all the address electrodes X1-Xm in the same direction. More specifically, the data signals may be supplied to all the address electrodes X1-Xm in a direction going from the data driver 1500 to the scan electrode Yn. In other words, the data signals supplied to all the address electrodes X1-Xm are supplied by one data driver 1500.

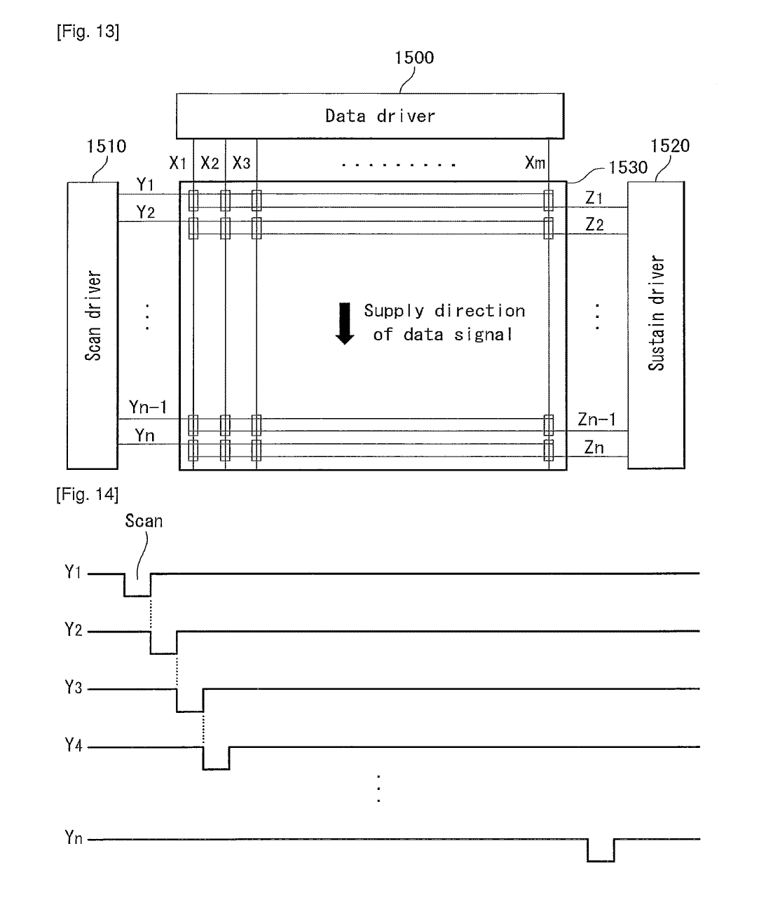

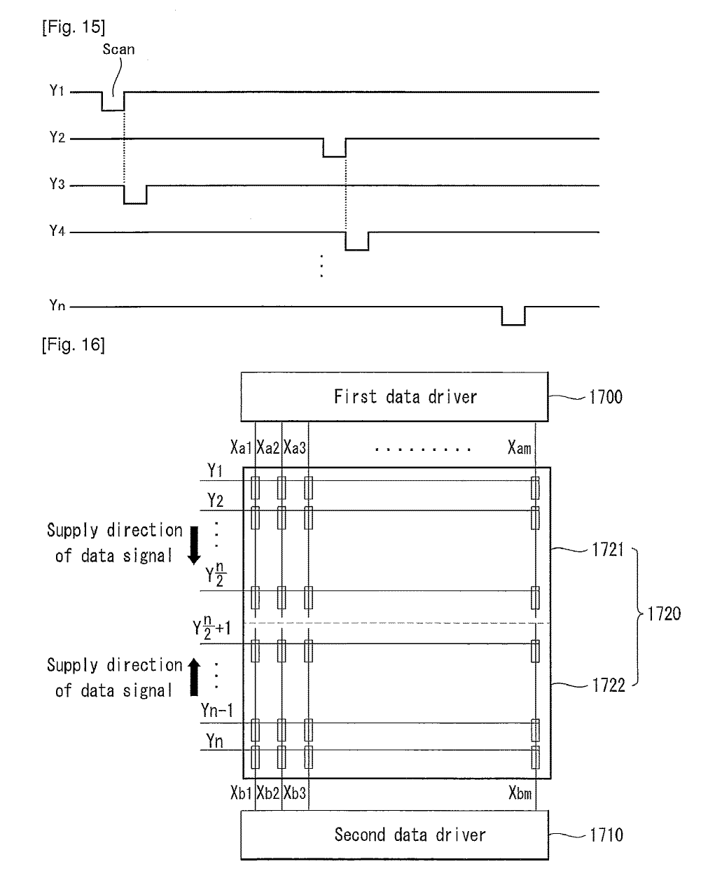

FIGS. 14 and 15 are diagrams for explaining a method of supplying a scan signal.

As shown in FIGS. 14 and 15, all the scan signals are supplied to the plurality of scan electrodes Y1-Yn at different times of an address period in an active area where an image is displayed.

For instance, as shown in FIG. 14, the scan signals (Scan) may be successively supplied to the scan electrodes Y1-Yn.

As shown in FIG. 15, after the scan signals (Scan) are successively supplied to the odd-numbered scan electrodes Y1, Y3, Y5 . . . . . . the scan signals (Scan) are successively supplied to the even-numbered scan electrodes Y2, Y4, Y6 . . . . . .

Although it is not shown, a dummy scan electrode may be positioned in a dummy area outside the active area. It is possible to supply the scan signal (Scan) to the dummy scan electrode. A time when the scan signal (Scan) is supplied to the dummy scan electrode may be substantially different from a time when the scan signal (Scan) is supplied to the scan electrode in the active area. The scan signal (Scan) may not be supplied to the dummy scan electrode.

As described above, in case that all the scan signals are supplied to the scan electrodes Y1-Yn at different times of the address period in the active area, time required to supply all the scan signals may excessively lengthen. In other words, a time width of the address period may excessively lengthen, and thus a driving margin may worsen.

Further, as the time width of the address period excessively lengthens, a time width of the sustain period shortens. Hence, a luminance may be reduced. In case that the number of subfields decreases so as to maintain the time width of the sustain period, representability of gray scale may fall.

On the other hand, in case that the phosphor layer includes the additive material (for example, the MgO material), the discharge delay time can be reduced. Therefore, although all the scan signals are supplied using the methods described in FIGS. 13 to 15, an excessive increase in the time width of the address period can be prevented. Hence, a driving margin can be sufficiently secured.

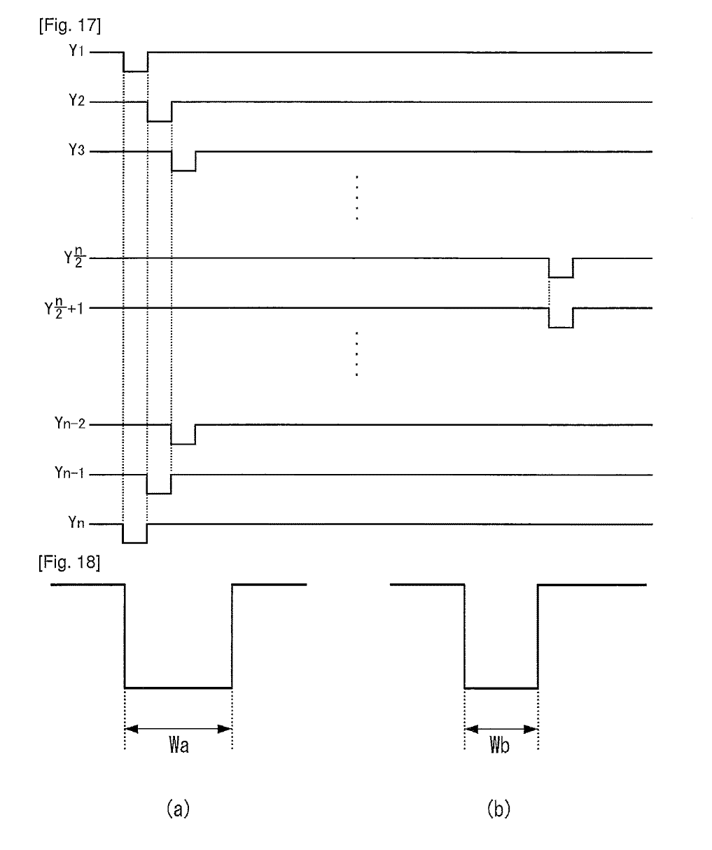

The data signals may be supplied in various supply directions by the plurality of the data drivers so as to secure the driving margin. This will be described below with reference to FIGS. 16 and 17.

FIG. 16 is a diagram for explaining another method of supplying a data signal, and FIG. 17 is a diagram for explaining another method of supplying a scan signal.

As shown in FIG. 16, the data driver may include a first data driver 1700 and a second data driver 1710.

The first data driver 1700 may supply data signals to address electrodes Xa1-Xam positioned in a first area 1721 of a plasma display panel 1720. The second data driver 1710 may supply data signals to address electrodes Xb1-Xbm positioned in a second area 1722 of the plasma display panel 1720.

A supply direction of the data signals supplied to the address electrodes Xa1-Xam in the first area 1721 is different from a supply direction of the data signals supplied to the address electrodes Xb1-Xbm in the second area 1722.

In this case, as shown in FIG. 17, while scan signals are supplied to scan electrodes Y1-Y(n/2) in the first area 1721, scan signals can be supplied to scan electrodes Y(n/2+1)−Yn in the second area 1722. Accordingly, time required to supply the scan signals and the data signals can be reduced by about 50% of the time required in FIGS. 13 to 15, and thus the driving margin can be sufficiently secured.

However, in FIGS. 16 and 17, the plasma display apparatus has to include two data drivers more than one data driver in FIGS. 13 to 15, and the address electrodes have to be divided into the address electrodes in the first area 1721 and the address electrodes in the second area 1722. As a result, this may cause an increase in the manufacturing cost of the plasma display apparatus.

On the other hand, in case that the phosphor layer includes the additive material such as the MgO materials, a discharge delay characteristic between the scan electrode and the address electrode can be improved. Hence, a width of the scan signal can be reduced. In other words, the driving margin can be sufficiently secured without the addition of the data driver, and thus it can be advantageous in the manufacturing cost.

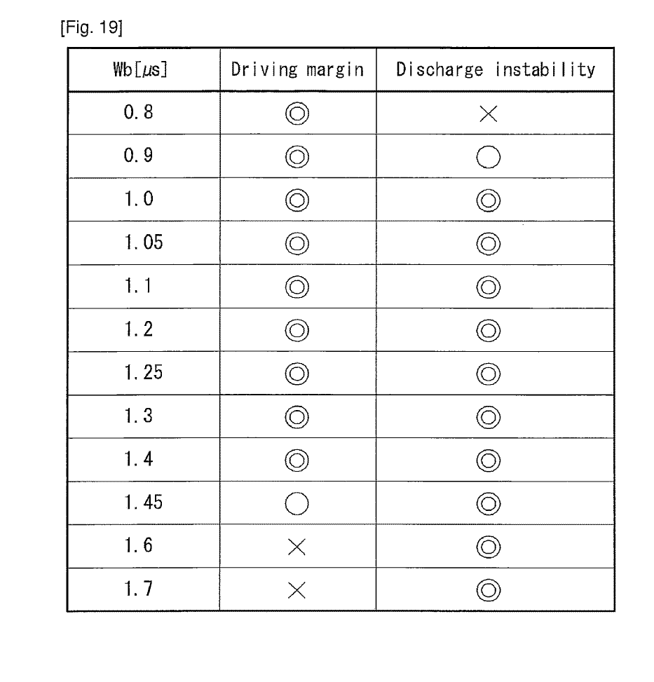

FIGS. 18 and 19 are diagrams for explaining a width of a scan signal.

In case that the phosphor layer does not include the additive material, a width of the scan signal may be Wa as shown in (a) of FIG. 18. In case that the phosphor layer includes the MgO material as the additive material, a width of the scan signal may be Wb smaller than the width Wa as shown in (b) of FIG. 18.

FIG. 19 is a table showing a driving margin and a discharge instability when the width Wb of the scan signal changes from 0.8 μs to 1.7 μs. In FIG. 19, a content of the MgO material is 20% based on volume of the phosphor layer.

In FIG. 19, “X” indicates that the driving margin is excessively small and the discharge instability is excessively high; “ο” indicates that the driving margin and the discharge instability are relatively good; and “⊚” indicates that the driving margin is sufficiently large and the discharge is sufficiently stable.

In terms of the diving margin, when the width Wb of the scan signal ranges from 0.8 μs to 1.4 μs, the driving margin is very good because of the sufficiently small width Wb.

When the width Wb of the scan signal is 1.45 μs, the driving margin is relatively good. On the other hand, when the width Wb of the scan signal is equal to or more than 1.6 μs, the driving margin is bad because of the excessively wide width Wb.

In terms of the discharge instability, when the width Wb of the scan signal is 0.8 μs, an address discharge is excessively weak or an address discharge may not even occur because of the excessively small width Wb. Therefore, the discharge instability is excessively high.

When the width Wb of the scan signal is 0.9 μs, the discharge instability is relatively stable. On the other hand, when the width Wb of the scan signal is equal to or more than 1.0 μs, an address discharge occurs stably because of the excessively wide width Wb. Therefore, the discharge instability is very low.

Considering the graph of FIG. 19, the width Wb of the scan signal may lie substantially in a range between 0.9 μs and 1.45 μs or 1.0 μs and 1.4 μs.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

1. A plasma display apparatus comprising:
a plasma display panel including:
a front substrate on which a plurality of scan electrodes and a plurality of sustain electrode are positioned substantially parallel to each other;
a rear substrate on which a plurality of address electrodes are positioned to intersect the scan electrodes and the sustain electrodes; and
a phosphor layer positioned between the front substrate and the rear substrate, the phosphor layer including a phosphor material and an additive material, the additive material including at least one of magnesium oxide (MgO), zinc oxide (ZnO), silicon oxide (SiO₂), titanium oxide (TiO₂), yttrium oxide (Y₂O₃), aluminum oxide (Al₂O₃), lanthanum oxide (La₂O₃), europium oxide (EuO), cobalt oxide, iron oxide, or CNT (carbon nano tube); and
a driver that supplies scan signals to the plurality of scan electrodes at different times of an address period of a subfield in an active area.

2. The plasma display apparatus of claim 1, wherein the driver supplies data signals corresponding to the scan signals to the address electrodes.

3. The plasma display apparatus of claim 1, wherein the additive material includes MgO material, and
the MgO material includes (200)-oriented MgO material and (111)-oriented MgO material, and a content of the (111)-oriented MgO material is less than a content of (200)-oriented MgO.

4. The plasma display apparatus of claim 1, wherein at least one of particles of the additive material is positioned on the surface of the phosphor layer.

5. The plasma display apparatus of claim 1, further comprising a lower dielectric layer between the phosphor layer and the rear substrate,
wherein at least one of particles of the additive material is positioned between the phosphor layer and the lower dielectric layer.

6. The plasma display apparatus of claim 1, wherein a percentage of a volume of the additive material based on a volume of the phosphor layer lies substantially in a range between 2% and 40%.

7. The plasma display apparatus of claim 1, wherein the phosphor layer includes a first phosphor layer emitting red light, a second phosphor layer emitting blue light, and a third phosphor layer emitting green light, and
the additive material is omitted in at least one of the first phosphor layer, the second phosphor layer, or the third phosphor layer.

8. A plasma display apparatus comprising:
a plasma display panel including:
a front substrate on which a plurality of scan electrodes and a plurality of sustain electrode are positioned substantially parallel to each other;
a rear substrate on which a plurality of address electrodes are positioned to intersect the scan electrodes and the sustain electrodes; and
a phosphor layer positioned between the front substrate and the rear substrate, the phosphor layer including a phosphor material and an additive material, the additive material including at least one of magnesium oxide (MgO), zinc oxide (ZnO), silicon oxide (SiO₂), titanium oxide (TiO₂), yttrium oxide (Y₂O₃), aluminum oxide (Al₂O₃), lanthanum oxide (La₂O₃), europium oxide (EuO), cobalt oxide, iron oxide, or CNT (carbon nano tube); and
a driver that supplies scan signals to the plurality of scan electrodes at different times of an address period of a subfield in an active area,
wherein a width of the scan signal lies substantially in a ranges between 1.0 μs and 1.4 μs.

9. The plasma display apparatus of claim 8, wherein at least one of particles of the additive material is positioned on the surface of the phosphor layer.

10. The plasma display apparatus of claim 8, further comprising a lower dielectric layer between the phosphor layer and the rear substrate,
wherein at least one of particles of the additive material is positioned between the phosphor layer and the lower dielectric layer.

11. The plasma display apparatus of claim 8, wherein a percentage of a volume of the additive material based on a volume of the phosphor layer lies substantially in a range between 2% and 40%.

12. The plasma display apparatus of claim 8, wherein the phosphor layer includes a first phosphor layer emitting red light, a second phosphor layer emitting blue light, and a third phosphor layer emitting green light, and
the additive material is omitted in at least one of the first phosphor layer, the second phosphor layer, or the third phosphor layer.

13. The plasma display apparatus of claim 8, wherein the additive material includes MgO material, and
the MgO material includes (200)-oriented MgO material and (111)-oriented MgO material, and a content of the (111)-oriented MgO material is less than a content of (200)-oriented MgO material.

14. A plasma display apparatus comprising:
a plasma display panel including:
a front substrate on which a plurality of scan electrodes and a plurality of sustain electrode are positioned substantially parallel to each other;
a rear substrate on which a plurality of address electrodes are positioned to intersect the scan electrodes and the sustain electrodes; and
a phosphor layer positioned between the front substrate and the rear substrate, the phosphor layer including a phosphor material and MgO material; and
a driver that supplies scan signals to the plurality of scan electrodes at different times of an address period of a subfield in an active area.

15. The plasma display apparatus of claim 14, wherein a width of the scan signal lies substantially in a ranges between 1.0 μs and 1.4 μs.

16. The plasma display apparatus of claim 14, wherein the MgO material includes (200)-oriented MgO material and (111)-oriented MgO material, and a content of the (111)-oriented MgO material is less than a content of (200)-oriented MgO material.

17. The plasma display apparatus of claim 14, wherein at least one of particles of the MgO material is positioned on the surface of the phosphor layer.

18. The plasma display apparatus of claim 14, further comprising a lower dielectric layer between the phosphor layer and the rear substrate,
wherein at least one of particles of the MgO material is positioned between the phosphor layer and the lower dielectric layer.

19. The plasma display apparatus of claim 8, wherein a percentage of a volume of the MgO material based on a volume of the phosphor layer lies substantially in a range between 2% and 40%.

20. The plasma display apparatus of claim 14, wherein the phosphor layer includes a first phosphor layer emitting red light, a second phosphor layer emitting blue light, and a third phosphor layer emitting green light, and
the MgO material is omitted in at least one of the first phosphor layer, the second phosphor layer, or the third phosphor layer.
